(19) United States
(12) Patent Application Publication
(10) Pub. No.: US 2012/0179357 A1
(43) Pub. Date: Jul. 12, 2012

(54) ROADWAY INFORMATION USE FOR ENGINE START/STOP SYSTEM

(75) Inventor: Anthony Mark Phillips, Northville, MI (US)

(73) Assignee: FORD GLOBAL TECHNOLOGIES, LLC., Dearborn, MI (US)

(21) Appl. No.: 13/004,386

(22) Filed: Jan. 11, 2011

(51) Int. Cl. F02D 17/02

(52) U.S. Cl. 701/112

(57) ABSTRACT

A vehicle includes an internal combustion engine. The vehicle includes a starter that engages with the engine to start the engine. The vehicle includes at least one sensor for detecting roadway information. A method of controlling the vehicle includes detecting roadway information with the at least one sensor while the vehicle is moving and the engine is running. The method further includes stopping the engine in the presence of a shutdown condition based on the roadway information, while the vehicle is moving.

### BACKGROUND

1. Technical Field

The invention relates to an engine start/stop system.

2. Background Art

An engine start/stop system for a vehicle stops the internal combustion engine when the vehicle is stopped, and then starts the internal combustion engine when the driver requests acceleration. The engine also may be started, for example, due to loads on the electrical system or due to the catalyst temperature being low. For example, the internal combustion engine may be stopped when the vehicle stops at traffic lights or stops in a traffic jam. This approach is known as static start/stop. The stopping of the engine when the engine is not needed improves fuel economy, and reduces emissions. Although, sometimes, the engine may stay on when the vehicle is stopped because the alternator needs to run due to loads on the electrical system, or the engine may stay on for other reasons such as, for example, when the catalyst temperature is too low. In some approaches, fuel economy may be improved by 3-4% with static start/stop.

Another type of start/stop system is known as rolling start/stop. Rolling start/stop involves stopping the internal combustion engine when the vehicle is moving.

It is critical to have confidence that the driver intends to decelerate the vehicle prior to shutting down the engine. If the driver did not continue to decelerate the vehicle, there could be a noticeable delay to re-accelerate the vehicle as the engine is restarted and begins to produce torque.

For the foregoing reasons, there is a need for an engine start/stop system that determines with confidence that the driver intends to decelerate the vehicle prior to shutting down the engine.

### SUMMARY

It is an object of the invention to provide an improved approach to implementing an engine start/stop system wherein roadway infrastructure and other information are used as indicators for the engine start/stop system.

It is a further object of the invention to provide an improved engine start/stop system suitable for a vehicle lacking electric drive capability. Embodiments of the invention are not limited to micro/mild hybrid vehicles.

In one embodiment, a method of controlling a vehicle is provided. The vehicle includes a starter that engages with the engine to start the engine. The vehicle includes at least one sensor for detecting roadway information. The method comprises detecting roadway information with the at least one sensor while the vehicle is moving and the engine is running. The method further comprises determining a shutdown condition for the engine, while the vehicle is moving, based on the roadway information. The method further comprises stopping the engine in the presence of the shutdown condition, while the vehicle is moving.

At the more detailed level, the invention comprehends various additional features that may be included individually or in various combinations in various embodiments of the invention. For example, the at least one sensor may comprise a forward-looking device from the group consisting of a camera, radar, and lidar. In turn, determining the shutdown condition further comprises identifying an approaching object based on the roadway information from the forward-looking device; and detecting a driver initiated deceleration of the vehicle. The shutdown condition is determined based on the approaching object and the driver initiated deceleration. In this particular approach, identifying the approaching object may further comprise identifying a stop light, and identifying a state of the stop light. As well, identifying the approaching object may further comprise identifying a road sign, or identifying another vehicle.

In another possible approach, the at least one sensor comprises an electronic horizon sensor which includes an embedded map database with global positioning system (GPS) information. The electronic horizon sensor provides roadway information based on vehicle location and direction of travel. Determining the shutdown condition further comprises identifying an approaching object based on the roadway information from the electronic horizon sensor; detecting a driver initiated deceleration of the vehicle; and determining the shutdown condition based on the approaching object and the driver initiated deceleration. Identifying the approaching object may further comprise identifying a stop location.

In one possible feature in embodiments of the invention, determining the shutdown condition may further comprise establishing a vehicle speed threshold, and determining a vehicle speed. The shutdown condition is determined further based on the vehicle speed and the vehicle speed threshold. The vehicle speed threshold may be a function of a distance to an approaching object. The shutdown condition is prevented when the vehicle speed exceeds the vehicle speed threshold. The vehicle speed threshold may be an adaptive threshold that adapts based on driver behavior. In this way, the vehicle speed threshold may increase or decrease to adapt to various types of drivers.

In yet another approach, the at least one sensor comprises a receiver for receiving infrastructure/vehicle-to-vehicle communications. Determining the shutdown condition further comprises identifying an approaching object based on the roadway information from the receiver. A driver initiated deceleration of the vehicle is detected. The shutdown condition is determined based on the approaching object and the driver initiated deceleration.

In another feature in embodiments of the invention, after stopping the engine, a driver initiated acceleration request is detected. The engine is started in response to the request.

In another embodiment of the invention, a method of controlling an engine of a moving vehicle including a server is provided. The method comprises detecting roadway information with the sensor while the vehicle is moving and the engine is running. The method further comprises stopping the engine in the presence of a shutdown condition based on the roadway information, while the vehicle is moving.

In another embodiment of the invention, a vehicle includes an internal combustion engine. The vehicle includes a starter that engages with the engine to start the engine. The vehicle includes at least one sensor for detecting roadway information. The vehicle includes at least one controller configured to detect roadway information with the at least one sensor while the vehicle is moving and the engine is running. In the presence of a shutdown condition based on the roadway information, the engine is stopped while the vehicle is moving.

### BRIEF DESCRIPTION OF THE DRAWINGS

FIG. 1 is a schematic representation of a powertrain system configuration;

FIG. 2 illustrates the controller and a sensor in the form of a forward-looking device;

FIG. 3 illustrates the controller and a sensor in the form of an electronic horizon sensor;

FIG. 4 illustrates the controller and a sensor in the form of an infrastructure-to-vehicle or vehicle-to-vehicle communication receiver;

FIG. 5 shows a graph depicting vehicle speed threshold as a function of distance in a method of determining if the driver is likely to stop;

FIG. 6 is a block diagram illustrating a method of the invention for an engine start/stop system utilizing roadway information;

FIG. 7 is a block diagram illustrating a further aspect of the invention; and

FIG. 8 is a block diagram illustrating a further aspect of the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The invention comprehends various aspects of an engine start/stop system wherein roadway infrastructure and other information are used as indicators for the engine start/stop system. Examples are described in further detail below.

The proliferation of new active features on vehicles provides a host of new sensors that can be used to better understand the environment that the vehicle is operating in and the driver's intention. One of these sensors is a forward-looking camera. In one embodiment of the invention, the forward-looking camera can be used to detect and identify road signs and stoplights. By having stop signs and (red) lights identified ahead of time, the vehicle can confidently stop the engine as the driver begins to decelerate for the sign or light, knowing that he/she intends to complete the stop.

In another embodiment of the invention, an electronic horizon (EH) sensor can provide similar information. This sensor is an embedded map database combined with GPS information (either with or without a navigation system). The EH system provides the most likely roadway information based on the vehicle's location and direction of travel. This roadway information includes upcoming stoplight and stop sign location information relative to the vehicle. By combining knowledge of the driver's action (deceleration) with information about the roadway ahead (stop sign and light location), the vehicle can better predict when the vehicle will be stopping and use this prediction to confidently turn off the engine.

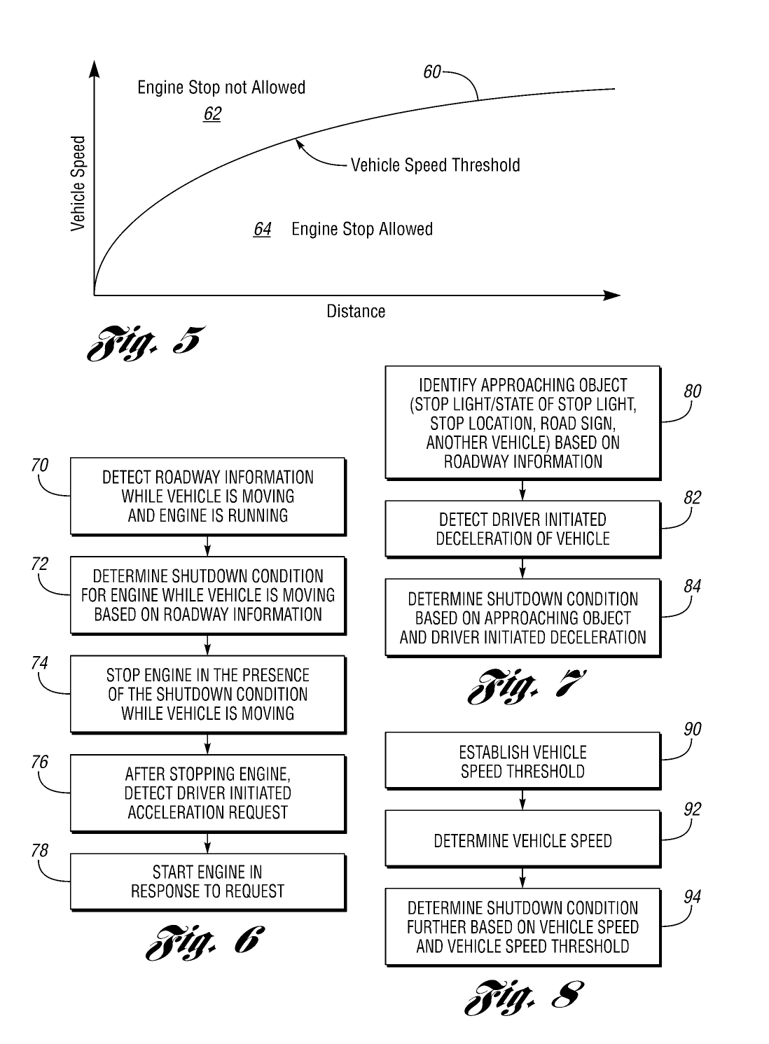

Unlike the camera, however, the EH sensor does not know the status (color) of stop lights so the prediction would rely more heavily on interpreting the driver's actions relative to the location of the light in order to ascertain that a stop was imminent. One method for determining if the driver was likely to stop at an upcoming light would be by assessing the vehicle speed relative to the maximum or typical (calibratible) speed that would be compatible with a stop in the distance available before the light. FIG. 5, described in more detail further below, shows a graph indicating how this speed might be calibrated. The “distance from stop” would be calculated using the vehicle's known position (from GPS) combined with the known position of the stop light from the map database.

In another embodiment, a method that could be used for determining that a stop is imminent is through the use of Infrastructure-to-Vehicle (12V) communication. In this case, “smart” traffic lights could wirelessly communicate their status to vehicles as the vehicles approach the light. If the traffic light indicated that it was red or yellow, and the driver began to decelerate, the vehicle could assume that the driver was going to stop and shut off the engine.

Embodiments of the invention have many advantages. For example, embodiments of the invention may facilitate more engine shutdowns in a vehicle implementing an engine start/stop system, while avoiding turning off the engine under conditions where the driver may change his or her mind. This may result in improved fuel economy and drivability of the vehicle.

Embodiments of the invention may be implemented in a variety of applications, and are not limited to any particular powertrain.

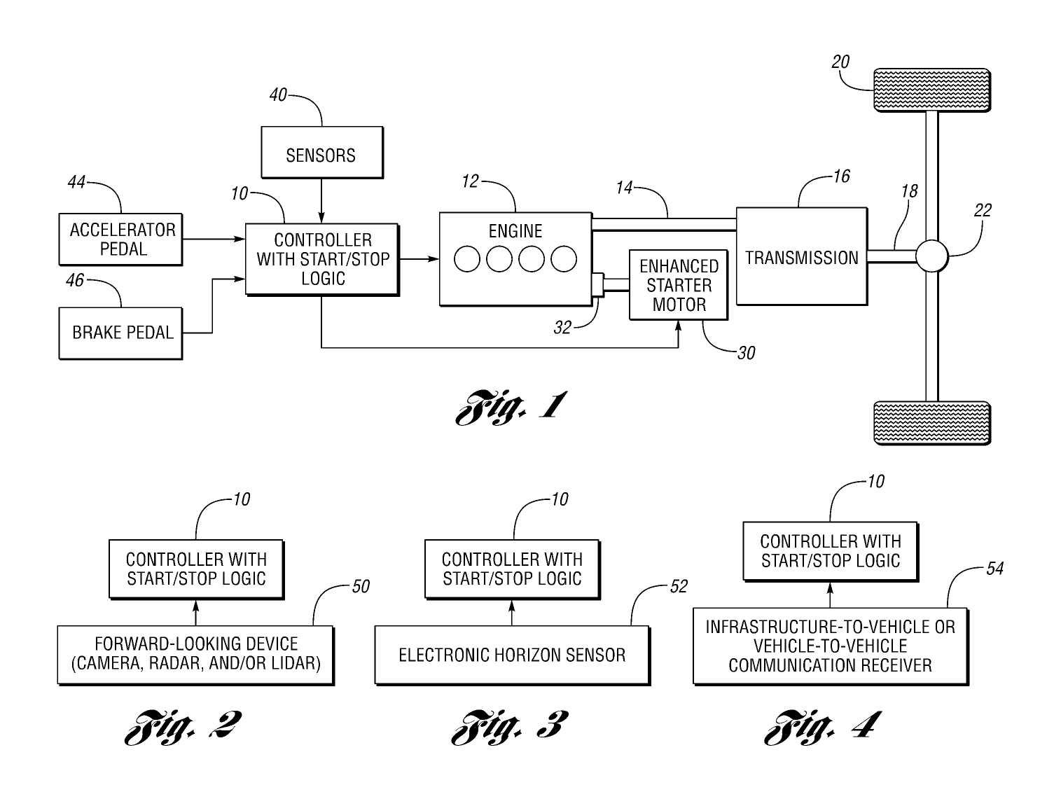

An example vehicle powertrain is shown in FIG. 1. A vehicle controller 10 includes appropriate logic/controls for implementing an engine start/stop system. An internal combustion engine 12, controlled by controller 10, distributes torque through torque input shaft 14 to transmission 16. The transmission 16 includes a torque output shaft 18 drivably connected to vehicle traction wheels 20 through a differential and axle mechanism 22.

An enhanced starter motor 30 is provided to implement the engine start/stop system. In general, controller 10 receives input from various vehicle sensors 40, accelerator pedal 44, and brake pedal 46. Controller 10 implements an engine start/stop system by, at appropriate times, stopping engine 12 by halting fueling and starting engine 12 with enhanced starter motor 30 which engages engine 12 through a suitable mechanism 32. The controller 10 may implement static start/stop in a known manner as understood by those skilled in the art.

In accordance with embodiments of the invention, controller 10 also implements dynamic start/stop wherein roadway infrastructure and other information are used as indicators for the engine start/stop system such that the start/stop system may stop the engine 12 while the vehicle is moving. Other aspects of the powertrain system of FIG. 1 may be implemented in a known fashion as is appreciated by those skilled in the art.

FIG. 2 illustrates the controller 10 and a sensor (40, FIG. 1) in the form of a forward-looking device 50. The forward-looking device 50 can be used to detect and identify road signs and stoplights (including the current state or color of the stoplight). In some embodiments of the invention, the forward-looking device 50 may be used to identify other vehicles, and may identify the status of brake lights. In general, forward-looking device 50 detects roadway information that may be used to identify an approaching object. The forward-looking device 50 could be a camera, or a radar or lidar implementation for active scanning, which is capable of detecting roadway information while the vehicle is moving and the engine is running. Based on this roadway information, the controller 10 may determine a shutdown condition for the engine while the vehicle is moving, and the engine may be stopped while the vehicle is still moving.

In further detail, upon identifying an approaching object such as a stop sign, stoplight, or another vehicle, if the controller 10 also detects a driver initiated deceleration of the vehicle which may be determined from the accelerator pedal 44 and/or brake pedal 46, the shutdown condition may be triggered. Put another way, by having stop signs and (red) lights identified ahead of time, the vehicle can confidently stop the engine as the driver begins to decelerate for the sign or light, knowing that he/she intends to complete the stop.

FIG. 3 illustrates the controller 10 and a sensor (40, FIG. 1) in the form of an electronic horizon sensor 52 which can provide similar information as forward-looking device 50 (FIG. 2). As noted previously, EH sensor 52 does not know the status (color) of stop lights so the prediction would rely more heavily on interpreting the driver's actions relative to the location of the light in order to ascertain that a stop was imminent.

FIG. 4 illustrates the controller 10 and a sensor (40, FIG. 1) in the form of an infrastructure-to-vehicle or vehicle-to-vehicle communication receiver 54. As noted previously, objects such as traffic lights or other vehicles could wirelessly communicate their status to vehicles as the vehicles approach the object. For example, if a traffic light indicated that it was red or yellow, and the driver began to decelerate, the vehicle could assume that the driver was going to stop and shut off the engine.

FIG. 5 shows a graph depicting vehicle speed threshold 60 as a function of distance in a method of determining if the driver is likely to stop. More specifically, the x-axis represents distance from stop (or object) and the y-axis represents vehicle speed. The x-axis may represent time from stop in an alternative. As shown, for a given distance from the stop location, if the vehicle speed exceeds the vehicle speed threshold 60 (region 62 on the graph), the engine start/stop system is prevented from stopping the engine because there is not a sufficient likelihood that the driver intends to stop. On the other hand, for a given distance from the stop location, if the vehicle speed does not exceed the vehicle speed threshold 60 (region 64 on the graph), the engine start/stop system is allowed to stop the engine.

In another possible feature, the distance on the x-axis represents the distance (or time in the alternative) to another moving vehicle, for example, on the highway. In this case, the y-axis represents relative speed of the driver's vehicle with respect to the other moving vehicle; the vehicle speed threshold 60 represents a relative speed threshold. In this feature, the engine could be stopped in a situation where the driver is slowing down while approaching another vehicle on the highway. In this feature, the start/stop system could also consider whether the other vehicle is braking, if such information is available.

Further, it is appreciated that the vehicle speed threshold may be an adaptive threshold that adapts based on driver behavior. In this way, the vehicle speed threshold may increase or decrease to adapt to various types of drivers.

FIG. 6 is a block diagram illustrating a method of the invention for an engine start/stop system utilizing roadway information. At block 70, roadway information is detected with the at least one sensor (sensors 40, FIG. 1; forward-looking device 50, FIG. 2; electronic horizon sensor 52, FIG. 3; receiver 54, FIG. 4) while the vehicle is moving and the engine is running. At block 72, a shutdown condition is determined for the engine while the vehicle is moving, based on the roadway information. At block 74, the engine is stopped in the presence of the shutdown condition, while the vehicle is moving. At block 76, after stopping the engine, a driver initiated acceleration request is detected. At block 78, the engine is started in response to the request.

FIG. 7 is a block diagram illustrating a further aspect of the invention. At block 80, an approaching object is identified, such as a stoplight or other stop location, road sign, or another vehicle). This identification is based on roadway information from the one or more sensors. At block 82, driver initiated deceleration of the vehicle is detected. At block 84, the shutdown condition is determined based on the approaching object and the driver initiated deceleration.

FIG. 8 is a block diagram illustrating a further aspect of the invention. At block 90, a vehicle speed threshold is established (FIG. 5). At block 92, vehicle speed is determined. At block 94, a shutdown condition is determined based on the vehicle speed and the vehicle speed threshold (and on the sensor information).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A method of controlling a vehicle including an internal combustion engine, the vehicle including a starter that engages with the engine to start the engine, the vehicle including at least one sensor for detecting roadway information, the method comprising:
detecting roadway information with the at least one sensor while the vehicle is moving and the engine is running;
determining a shutdown condition for the engine, while the vehicle is moving, based on the roadway information; and
stopping the engine in the presence of the shutdown condition, while the vehicle is moving.

2. The method of claim 1 wherein the at least one sensor comprises a forward-looking device from the group consisting of a camera, radar, and lidar, and wherein determining the shutdown condition further comprises:
identifying an approaching object based on the roadway information from the forward-looking device;
detecting a driver initiated deceleration of the vehicle; and
determining the shutdown condition based on the approaching object and the driver initiated deceleration.

3. The method of claim 2 wherein identifying the approaching object further comprises:
identifying a stop light; and
identifying a state of the stop light.

4. The method of claim 2 wherein identifying the approaching object further comprises:
identifying a road sign.

5. The method of claim 2 wherein identifying the approaching object further comprises:
identifying another vehicle.

6. The method of claim 1 wherein the at least one sensor comprises an electronic horizon sensor which includes an embedded map database with global positioning system (GPS) information, the electronic horizon sensor providing roadway information based on vehicle location and direction of travel, and wherein determining the shutdown condition further comprises:
identifying an approaching object based on the roadway information from the electronic horizon sensor;
detecting a driver initiated deceleration of the vehicle; and
determining the shutdown condition based on the approaching object and the driver initiated deceleration.

7. The method of claim 6 wherein identifying the approaching object further comprises:
identifying a stop location.

8. The method of claim 6 wherein determining the shutdown condition further comprises:
establishing a vehicle speed threshold;
determining a vehicle speed;
determining the shutdown condition further based on the vehicle speed and the vehicle speed threshold.

9. The method of claim 8 wherein the vehicle speed threshold is a function of a distance to the approaching object.

10. The method of claim 9 wherein the shutdown condition is prevented when the vehicle speed exceeds the vehicle speed threshold.

11. The method of claim 8 wherein the vehicle speed threshold is an adaptive threshold that adapts based on driver behavior.

12. The method of claim 1 wherein the at least one sensor comprises a receiver for receiving infrastructure/vehicle-to-vehicle communications, and wherein determining the shutdown condition further comprises:
identifying an approaching object based on the roadway information from the receiver;
detecting a driver initiated deceleration of the vehicle; and
determining the shutdown condition based on the approaching object and the driver initiated deceleration.

13. The method of claim 1 wherein determining the shutdown condition further comprises:
establishing a vehicle speed threshold;
determining a vehicle speed;
determining the shutdown condition further based on the vehicle speed and the vehicle speed threshold.

14. The method of claim 13 wherein the vehicle speed threshold is a function of a distance to an approaching object detected by the at least one sensor.

15. The method of claim 14 wherein the shutdown condition is prevented when the vehicle speed exceeds the vehicle speed threshold.

16. The method of claim 13 wherein the vehicle speed threshold is an adaptive threshold that adapts based on driver behavior.

17. The method of claim 1 further comprising:
after stopping the engine, detecting a driver initiated acceleration request; and
starting the engine in response to the request.

18. A method of controlling an engine of a moving vehicle including a sensor, the method comprising:
detecting roadway information with the sensor while the vehicle is moving and the engine is running; and
stopping the engine in the presence of a shutdown condition based on the roadway information, while the vehicle is moving.

19. A vehicle including an internal combustion engine, the vehicle including a starter that engages with the engine to start the engine, the vehicle including at least one sensor for detecting roadway information, the vehicle including at least one controller configured to:
detect roadway information with the at least one sensor while the vehicle is moving and the engine is running; and
stop the engine in the presence of a shutdown condition based on the roadway information, while the vehicle is moving.

20. The vehicle of claim 19 wherein the at least one sensor comprises a forward-looking device from the group consisting of a camera, radar, and lidar, and wherein the at least one controller is further configured to:
identify an approaching object based on the roadway information;
detect a driver initiated deceleration of the vehicle; and
determine the shutdown condition based on the approaching object and the driver initiated deceleration.
